(19) United States
(12) Patent Application Publication
(10) Pub. No.: US 2026/0014970 A1
(43) Pub. Date: Jan. 15, 2026

(54) METHOD FOR ADJUSTING TENSIONING FORCES IN AN ELECTROMECHANICAL WHEEL BRAKE

(71) Applicant: Continental Automotive Technologies GmbH, Hannover (DE)

(72) Inventors: Jürgen Böhm, Oberneisen (DE); Timo Sauerwald, Waldems (DE); Peter Stauder, Mainz (DE)

(73) Assignee: Continental Automotive Technologies GmbH, Hannover (DE)

(21) Appl. No.: 19/266,133

(22) Filed: Jul. 10, 2025

(30) Foreign Application Priority Data
Jul. 12, 2024 (DE) 10 2024 206 608.7

(51) Int. Cl. B60T 8/172; B60T 13/74; B60T 17/22

(52) U.S. Cl. CPC B60T 8/172; B60T 13/746; B60T 17/221; B60T 2270/406

(57) ABSTRACT

The embodiments relate, in general, to a method for adjusting tensioning forces in an electromechanical wheel brake of a motor vehicle and to a motor vehicle brake having an electromechanical wheel brake designed in such a way. The method for controlling an actuator for a brake actuator of an electromechanical wheel brake, provides, inter alia, for the carrying out of an initialization function for determining a first offset position and the subsequent correction of the setpoint position of the actuator by the determined first offset position.

### TECHNICAL FIELD

The embodiment relate, in general, to a method for adjusting tensioning forces in an electromechanical wheel brake of a motor vehicle and to a motor vehicle brake having such an electromechanical wheel brake.

### BACKGROUND

Electromechanically actuable motor vehicle brakes are increasingly being used as braking systems for motor vehicles. These motor vehicle brakes offer a number of compensations compared to conventional, hydraulically actuated wheel brakes. For example, there is no longer any need for a complex hydraulic system, and an electromechanical wheel brake also takes up less space.

Electromechanical wheel brakes of this kind typically have an electric or electronic drive unit, which interacts with a mechanism or a transmission. A brake unit can then be arranged on the output side and, during operation, can bring about a deceleration of the wheel assigned to the brake unit. The electric drive unit can comprise an electrically driven motor, also referred to below as an actuator. Controlling the force of such actuators is of importance since-unlike, for example, in the case of hydraulically actuable wheel brakes-among other things, it is no longer possible for a driver to receive feedback.

Therefore, a force controller unit, which can comprise a force controller, is generally provided for controlling the actuator. The force controller can generate a setpoint value for the actuator speed or rotational speed on the basis of a specified setpoint force, which can correspond to a driver's braking request, in order to adjust said setpoint force as quickly as possible. In this way, the wheel brake can be applied, i.e., the desired tensioning force of the electromechanical wheel brake can be applied or a predetermined, defined braking torque can be adjusted.

To adjust the requested application forces, expansion forces or braking torques with a correspondingly required degree of accuracy, conventionally sometimes force sensors or braking torque sensors are used for each brake unit or wheel brake. Therefore, the space required to integrate the sensors in the mechanical design of the brake unit is also a hindrance here.

In order to remedy this, methods are being developed in which such sensors can be dispensed with. A method of this type is described, for example, in the applicant's document DE 10 2022 205 632 A1.

The method described there makes provision to represent the relationship between an application force and an application travel of the actuator in the form of a characteristic curve.

It has been shown that, in the model under consideration, there may be deviations in the actual relationship between the application force and the application travel, for example due to wear of a brake disk or of the brake linings, which can lead to inaccuracies in the adjustment of the forces.

Accordingly, a method for controlling an actuator, in particular a brake actuator of an electromechanical wheel brake of a motor vehicle, which method does not have the above-mentioned difficulties or at least mitigates them, is desirable. For example, it is also intended to be possible to dispense with additional sensors on or in the wheel brake.

### SUMMARY

This object is achieved by a method for controlling an actuator and a suitably designed brake control unit and a motor vehicle as disclosed.

The embodiment therefore relate, in a first aspect, to a method for controlling an actuator, for example a brake actuator of an electromechanical wheel brake, for applying a requested tensioning force.

The method may comprise the following steps, possibly in the sequence shown:
determining a setpoint application force F_{Sp,soll},
determining a corresponding setpoint position of the actuator X_{Akt,Soll} for applying the setpoint application force F_{Sp,soll},
carrying out an initialization function for determining a first offset position X_{Offset,1} as the zero point of the coordinate system for determining X_{Akt,Soll} from the setpoint application force F_{Sp,soll}, when there is an activation condition for carrying out the initialization function,
determining a second offset position X_{Offset,2} when a motor torque threshold value M_{LS,Korr,Limit} is exceeded,
correcting the actuator setpoint position X_{Akt,Soll} by means of a correction value ΔX_{LS,Korr} determined therefrom, wherein the following applies:

$${X}_{Akt , Soll , Korr} = {X}_{Akt , Soll} + Δ {X}_{LS , Korr} ,$$

and
activating the actuator to reach the setpoint position with X_{Akt,Soll,Korr}.

The actuator can comprise an electric motor, for example an electric motor for operating an electromechanical wheel brake as a constituent part of a motor vehicle brake of a motor vehicle. Within the context of the embodiments, a motor vehicle may mean a vehicle having axles, wherein at least one of these axles can comprise steerably guided wheels and, furthermore, the drive of the wheels of at least one axle can be adapted in a wheel-specific manner.

In a motor vehicle brake of this type, the brake pedal can be decoupled from the brake system, and the wheel brakes can be realized by electromechanically actuable brakes (“EMB”). The electromechanically actuable brakes may be designed either as electromechanical disk brakes (e-caliper) or as electromechanically actuated drum brakes (e-drum).

The electromechanical disk brakes (e-caliper) may be designed in such a way that an application force can be produced by means of the electric motor, an auxiliary transmission and a rotation-translation mechanism. The application force, that is to say the force with which the brake linings are pressed against the brake disk, then produces a corresponding braking torque at the wheel in question. Depending on the embodiment and control concept, the activation of the electromechanical disk brakes can be such that either a specified, defined tensioning force or a specified, defined braking torque can be adjusted in accordance with the deceleration demand requested.

The electromechanically actuable drum brakes (e-drum) may be designed in such a way that a motor/transmission unit actuates an expansion module which presses the brake linings against the brake drum with an expansion force determined on the basis of the desired deceleration requested and thus produces a corresponding braking torque. Corresponding arrangements and designs, like the electromechanical disk brake, are sufficiently well known to a person skilled in the art. Even in the case of the electromechanically actuable drum brake, the control system, depending on the embodiment and control concept, can be designed in such a way that a defined expansion force or a braking torque can be adjusted in accordance with the deceleration demand.

The methods described below and the controller structures illustrated are shown by way of example using the example of an electromechanical disk brake for adjusting defined application forces. A transfer to an electromechanical drum brake for adjusting defined expansion forces or braking torques is easily possible for a person skilled in the art.

The method makes it possible that corresponding sensors, such as force sensors, do not have to be used, and therefore—at least with regard to the methods shown here—additional sensors can be dispensed with. The present embodiments make use of the fact that information which is already available can be determined, for example, on the basis of the actuator signals and can be used accordingly. These signals can comprise the actuator torque or motor torque and the actuator position or the motor angle.

At this point, it should be noted that no distinction is made between the German terms “steuern” [open-loop control] and “regeln” [closed-loop control] within the context of the present embodiments. The meaning of the corresponding terms is clear from the respective context.

Basic methods for activating such actuators can be gathered from the applicant's DE 10 2021 207 347 A1, for example, which is incorporated by reference in its entirety the subject matter of the present disclosure. If there is a deceleration demand or a braking force request, i.e. a request for applying a defined setpoint application force F_{Sp,Soll} or a defined braking torque, the actuator is moved in the application direction from its standby position X_{Standby} (“Standby Position”) in the application direction. If there is no request or if an existing application request is reset again, the actuator is transferred into, and held in, an unactuated state, in which a defined distance from the brake lining to the brake disk, also referred to as a release clearance, is present, so that there is no residual braking torque.

The relationship between an application force and an application travel of the actuator can be represented in the form of a characteristic curve or by means of a characteristic curve function and stored in a non-volatile memory, for example of an associated brake control unit, wherein, as an alternative to the application travel of the actuator for example in the case of a translational consideration, use may also be made, for example, of a motor angle in the case of a rotational consideration. Both variables are clearly linked to one another by the transmission gear of the electromechanical drive train.

While known arrangements may have the difficulty that deviations in the actual relationship between the application force as a function of the application travel and the underlying model may lead to errors in the adjustment of the forces, the present embodiments afford the possibility of being able to detect the contact position very precisely and to use it for controlling the actuator or force control.

The present embodiments thus enable an adjustment of a requested application force for an electromechanical brake actuator, with the use of an otherwise customary force or braking torque sensor per wheel brake being able to be dispensed with. The information required for the application of the forces is determined on the basis of the actuator signals. As shown below, these signals can affect the actuator torque or motor torque and/or the actuator position or the motor angle. These variables are already available because of the underlying actuator control.

The method for controlling the actuator can firstly provide detecting a braking force request. For this purpose, it is possible to determine a corresponding setpoint application force F_{Sp,soll}, which defines the setpoint force, which typically is intended to be immediately adjusted as quickly as possible. For this purpose, use can be made of a correspondingly designed force controller, which can be implemented in a brake control unit. The braking force request can be provided, for example, by a pedal unit or a superordinate vehicle computer.

A force controller can be understood to mean, for example, a functional unit, which realizes the functions mentioned. For example, it can be of modular construction. The force controller can be implemented, for example, using hardware or using software. It can be designed, for example, as a microcontroller, microprocessor, application-specific integrated circuit (ASIC), programmable logic controller or as another programmable or hard-wired unit. For example, the force controller can have processor means and storage means, wherein program code is stored in the storage means, the processor means executing a functionality as specified herein when the program code is executed.

On the basis of the braking force request, a setpoint position X_{Akt,Soll} can be determined for the actuator. This setpoint position determines the position of the actuator at which the desired braking force is adjusted at the wheel brake.

Wear of the friction partners in the operation of the motor vehicle brake or also for other reasons may lead to inaccuracies or deviations or changes, which are not stored in the model and which can therefore lead to the predetermined relationship between the application force and the application distance of the actuator no longer corresponding to the current relationship.

According to the embodiments, it is therefore proposed to carry out an initialization function. This initialization function can be carried out for example if a corresponding activation condition for carrying out the initialization function is provided. The activation condition may relate, for example, to the switching on of the actuator or the brake control unit for the first time and/or to the absence of a braking force request, e.g. over a predefined period of time. In other words, an initialization function can be carried out, for example, after the brake control unit is switched on or during a phase in which no braking force request is made to the actuator while operation is in progress.

The initialization function aims to determine a first offset position X_{Offset,1}, which is used to define the zero point of the actuator position in such a way that, in this position, the application force corresponds specifically to the value 0 and thus the variable stored in the characteristic curve for the actuator position for reaching a predetermined application force can be achieved with an actually required actuator position for actually reaching said application force.

For this purpose, according to an embodiment, the actuator can be moved in the application direction at a defined, but low, motor rotational speed and/or a limited motor torque. The initialization function can therefore comprise at least the following steps, e.g. in the indicated sequence:
activating the actuator at a predetermined rotational speed ω_{Mot,Ini} and/or a predetermined motor torque M_{Mot,Ini},
detecting the associated actuator position X_{Aktuator}=X₁, at which the motor rotational speed of the actuator assumes a value of approximately 0 rpm and/or at which the actuator position remains approximately constant,
determining the first offset position X_{Offset,1} from the associated actuator position X₁ and the travel distance from the standby position of the actuator X_{Standby}.

The actuator can be moved by the friction brake in the movement region of the release clearance or the travel distance without opposingly directed forces. As soon as the friction partners of the friction brake are pressed together and the actuator begins to build up force, the actuator movement can come to a standstill because of the extremely limited motor torque at a low force. This standstill can be detected using the motor rotational speed, which then assumes a value of approx. 0 rpm or using the current actuator position, which in this case no longer changes or no longer increases.

If a standstill is detected at the actuator position, this position can be used to determine a contact position by the actuator position at the standstill being corrected by the first offset position. The newly initialized zero point of the actuator position is now defined by setting the determined actuator position to the value 0 at a standstill after the correction by the first offset position has been made. With this initialization point, the zero point of the actuator actual position is thus determined, whereas in the case of the release clearance correction described in more detail below, a second offset position X_{Offset,2} is determined to obtain a correction value with which the actuator setpoint position can then be corrected.

The actuator can then be activated in order to apply the setpoint application force corresponding to the desired braking force request, with the actuator position, provided that an initialization has taken place. If no initialization takes place, the actuator can be activated as standard with the actuator position according to the characteristic curve. On the basis of the last position stored in a memory, before the actuator is switched off a first initialization of the actuator position can be undertaken and can then be corrected as the operation progresses.

In this way, a change in the release clearance can be compensated for.

During a brake actuation requested during normal operation, an actuator position corresponding to the setpoint application force can thus be adjusted.

A development can make provision to check this corrected contact position and to further adjust it as the operation progresses. In this way not only can the first offset position be continuously checked and further corrected, but also further changes that may result from the operation of the wheel brake can be taken into account. This may include, for example, greater wear of a friction partner, such as a brake disk or the friction linings, during a long downhill descent.

For this purpose, the course of the motor torque can be continuously monitored during an application movement. The fact that the motor torque to be applied by the actuator is proportional to the applied tensioning force can be taken as the basis here. If acceleration—and/or speed-dependent components are taken into account, the result is a so-called normalized motor torque adjusted for these components. The motor torque signal determined in this way can subsequently be monitored for exceeding a predefined torque threshold.

As soon as the friction linings are positioned on one another and/or pressed together, the actuator begins to build up a tensioning force.

If the normalized torque exceeds the predefined torque threshold for the application movement under consideration, the currently determined contact position can be determined from the associated actuator position and corrected by a second offset value.

Said contact position can then be corrected, for example, by means of a further correction value, with the currently determined contact position, according to an embodiment, being able to be weighted with a tracking factor. When the tracking factor is determined, it may be possible to find a compromise between the stability and sufficiently good filtering, on the one hand, which indicates a tracking factor close to one, and a high adjustment speed, which indicates a small tracking factor close to zero.

For the realization of the above-mentioned methods, the force controller, according to a further embodiment, can be supplemented by a characteristic curve correction controller. The force controller and/or characteristic curve correction controller can be implemented in the brake control unit.

The characteristic curve correction controller can be designed to generate a correction position as the manipulated variable for correcting the actuator setpoint position determined on the basis of the characteristic curve.

According to a development, this characteristic curve can be changed, with the underlying characteristic curve function being able to be adapted. For this purpose, provision is made to use the manipulated variable of the correction controller to adjust the force/displacement characteristic curve or the characteristic curve function.

This can occur after the braking has ended and/or when the brake control unit is switched off, and therefore there are no negative influences on a pending or current braking event. The actuator may be in the standby position.

The correction values of the actuator position determined by the correction controller during braking can be taken into consideration. For this purpose, it is also possible to define a further correction parameter, which can be determined on the basis of the correction values.

For simplification purposes, it is also possible to this end to adopt a model for changing the characteristic curve, according to which the new characteristic curve is obtained in a known contact position by stretching or compressing the original characteristic curve.

According to a further embodiment, the change can also be made in such a way that the lower, “soft” range of the force/displacement characteristic curve is not taken into account for the characteristic curve correction.

For this purpose, a current value for the characteristic curve correction parameter can be determined during the actuation of the wheel brake and with an activated correction controller in each controller sampling step. The value determined in this way can be filtered again to smooth out fluctuations and interference excitation. The result is then a filtered value. The new characteristic curve correction value can then be calculated after braking has ended.

According to a further development, it may also be provided to use a controller structure, which does not require a characteristic curve function as described above and can therefore be further simplified.

As with the above-mentioned characteristic curve correction controller, in this method, the setpoint application force can be converted into a corresponding motor torque setpoint value and the normalized motor torque can be considered to be the control variable.

The basic structure of this controller structure can comprise two controllers which are arranged in parallel and which both determine a setpoint value for the motor speed as the manipulated variable. Depending on the setpoint application force, another controller component may be provided, which decides which of these two setpoint values is supplied to a subordinate motor rotational speed controller.

For example, if the setpoint application force is zero or is less than a deactivation threshold, the brake can be released and the lining release clearance can be approached by stipulation of the target position using the actuator position controller or the brake remains in this position.

A further controller can be designed to determine the setpoint rotational speed as the manipulated variable on the basis of the difference between the normalized setpoint motor torque and the normalized actual torque in order to adjust the requested setpoint application force. This controller can therefore act as a force controller. This controller has to have a proportionally acting behavior; additional components (e.g. I component or D component) are optional. Furthermore, it can also be provided that the proportional component has a nonlinear characteristic, e.g. so that the controller can work with higher gain factors in the release clearance and in the lower force range, where the stiffness of the brake is still low, than in a high force range, in which the stiffness of the brake is substantially greater.

According to a further development, it can be provided that, in a force-holding phase, the motor torque is reduced by the stipulation of a modified setpoint torque, since predetermined tensioning forces are adjusted by stipulation of normalized motor torques.

A force-holding phase can be detected by the fact that the setpoint force gradient is approximately equal to the value zero and the ensuing actuator position is also detected as being approximately constant. In this case, the magnitude of the setpoint motor torque can then be gradually reduced as long as the actuator position does not change in the release direction during this process.

According to a further development, a safety factor may also be provided, which represents a safety distance from the motor torque setpoint value in the event of a force reduction.

The embodiments furthermore comprise, in a further aspect, a brake control unit, designed for controlling an actuator, for example a brake actuator of an electromechanical wheel brake, by means of a method as explained above. For this purpose, the brake control unit can comprise at least one characteristic curve correction controller, which is designed to determine a correction position as the manipulated variable for correcting the setpoint position of the actuator.

The embodiments furthermore comprise, in yet another aspect, a motor vehicle having a motor vehicle brake, for example comprising at least one electromechanical wheel brake, having at least one brake control unit as described herein.

The present embodiments permit the application of requested, defined forces in an electromechanical wheel brake without the use of a corresponding force sensor and using the force information contained in the motor torque and motor angle or motor position signals.

Further details of the invention are apparent from the description of the illustrated exemplary embodiments and the attached claims.

### BRIEF DESCRIPTION OF THE DRAWINGS

In the drawings:

FIG. 1 shows a simplified block diagram of a controller arrangement for adjusting defined tensioning forces without force sensors,

FIG. 2 shows the relationship between the setpoint tensioning force and the application travel of the actuator,

FIG. 3 shows the relationship between the setpoint tensioning force and the application travel of the actuator with a first offset position,

FIG. 4 shows a simplified block diagram of a basic structure of a force controller,

FIG. 5 shows a simplified block diagram of a basic structure of a force controller with a characteristic curve correction controller,

FIG. 6 shows a simplified block diagram of an arrangement of a controller structure with lining contact detection and tracking and with a characteristic curve correction controller,

FIG. 7 shows a simplified block diagram of a simplified controller structure, and

FIG. 8 shows a simplified block diagram of the controller structure from FIG. 7 with an extension.

### DETAILED DESCRIPTION

In the following detailed description of the embodiments, for the sake of clarity, the same reference signs denote substantially identical parts in or on these embodiments.

The method for controlling an actuator, for example a brake actuator of an electromechanical wheel brake, comprises the following steps, e.g. in the sequence shown:
determining a setpoint application force F_{Sp,soll},
determining a corresponding setpoint position of the actuator X_{Akt,Soll} for applying the setpoint application force F_{Sp,soll},
carrying out an initialization function for determining a first offset position X_{Offset,1} as the zero point of the coordinate system for determining X_{Akt,Soll} from the setpoint application force F_{Sp,soll}, when there is an activation condition for carrying out the initialization function,
determining a second offset position X_{Offset,2} when a motor torque threshold value M_{LS,Korr,Limit} is exceeded,
correcting the actuator setpoint position X_{Akt,Soll} by means of a correction value ΔX_{LS,Korr} determined therefrom, wherein the following applies:

$${X}_{Akt , Soll , Korr} = {X}_{Akt , Soll} + Δ {X}_{LS , Korr} ,$$

and
activating the actuator to reach the setpoint position with X_{Akt,Soll,Korr}.

The actuator comprises an electric motor, for example an electric motor for operating an electromechanical wheel brake as a constituent part of a motor vehicle brake of a motor vehicle. The electromechanically actuable wheel brakes can be designed as electromechanical disk brakes or as electromechanically actuated drum brakes. The methods described below and the controller structures illustrated are shown for the sake of simplicity using the example of an electromechanical disk brake for adjusting defined application forces.

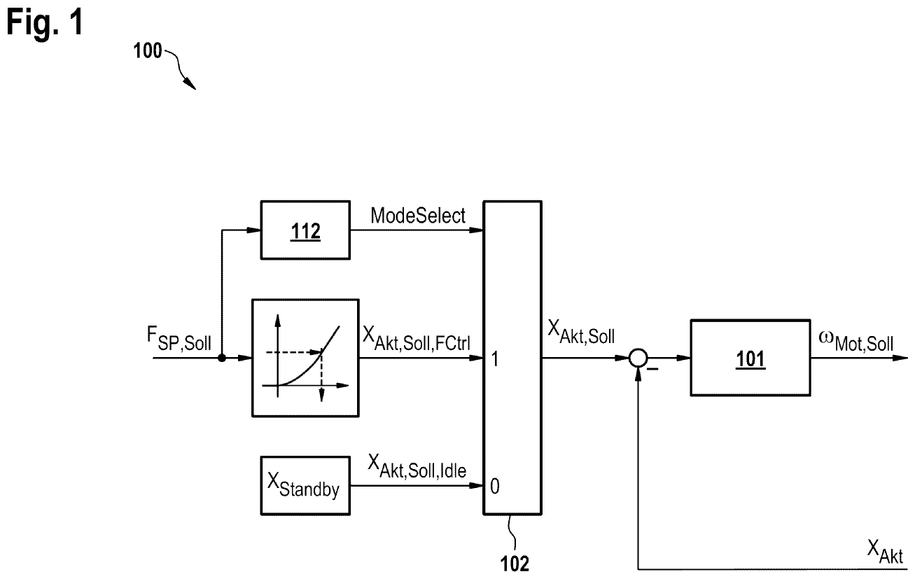

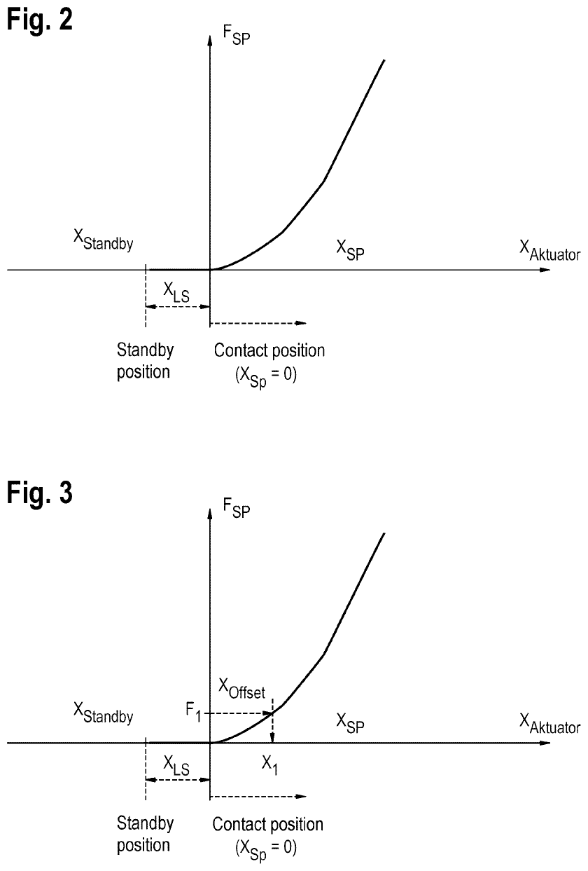

FIG. 1 shows a simplified block diagram of a part of an exemplary controller arrangement 100 for adjusting defined tensioning forces, which manages without force sensors, i.e., without additional sensors, for example force sensors. The application force controllers shown in FIGS. 1 and 2 substantially correspond to the prior art and are the basis for the present embodiments.

If there is a deceleration demand or a braking force request, i.e., a request for applying a defined setpoint application force F_{Sp,Soll}, the actuator is moved from its inoperative position X_{Standby} in the application direction. If there is no request or if an existing application request is reset again (F_{Sp,Soll}=0), the actuator is transferred into, and held in, an unactuated state, in which a defined distance from the brake lining to the brake disk, also referred to as a release clearance, is present, so that there is no residual braking torque.

For this purpose, in the controller arrangement 100 shown, a selection module 102 is provided in the controller arrangement 100, the selection module selecting how the actuator is to be activated and which position the actuator is to adopt. For this purpose, a “ModeSelect” signal is provided, which is provided by a module 112 for determining the target position to be set. This signal can assume the values of zero or one. For the unactuated state, the “ModeSelect” signal is defined in accordance with the arrangement according to FIG. 1 in such a way that the actuator position controller 101 sets the target position X_{Akt,Soll,Idle} (“ModeSelect”=0). In this case, X_{Akt,Soll}=X_{Akt,Soll,Idle}=X_{Standby} thus holds true. This position corresponds to the position where a defined distance between the brake lining and the brake disk is maintained.

If there is a deceleration demand, the “ModeSelect” signal can be defined in such a way that the setpoint value X_{Akt,Soll}=X_{Akt,Soll,FCtrl} is determined for the actuator position controller 101 (“ModeSelect”=1). The setpoint value corresponds to the value resulting from the relationship between the application force and the application travel. The manipulated variable for this position control loop is a setpoint value for the rotational speed controller (not shown) for controlling the rotational speed w of the electric motor.

The relationship between the application force F_{SP} and the application travel X_{Akt} of the actuator is stored in the form of a characteristic curve or a characteristic curve function. For this purpose, FIG. 2 shows an exemplary view of this relationship. The characteristic curve function is stored for this purpose in a non-volatile memory of the associated brake control unit. However, it may also be stored in an associated central computer or on-board computer.

As an alternative to the application travel X_{Akt} for example in the case of a translational consideration, a motor angle φ_{Akt} or φ_{SP}, in the case of a rotational consideration, can also be used, for example. Both variables are clearly linked to one another by the transmission gear of the electromechanical drive train.

For the method, a simplified model for the actuator dynamics in the form of the differential equation shown below is based on:

$${M}_{Mot} = {J}_{Ges} * d ( {ω}_{Mot} ) / dt +$$

$$i * {F}_{Sp} * ( 1 + {μ}_{+ -} * sign ( {ω}_{Mot} ) ) + {M}_{c 0 + -} * sign ( {ω}_{Mot} ) + {K}_{D} * {ω}_{Mot}$$

where:
   M_{Mot} Motor torque
   J_{Ges} Overall moment of inertia referring to the motor side
   ω_{Mot} Motor angle speed or motor rotational speed
   I Transmission ratio of auxiliary transmission and rotation/translation transmission
   F_{Sp} Tensioning force
   X_{Sp} Application travel
   M_{c0+-} Constant proportion of friction dependent on the direction of rotation or basic friction
   sign(ω_{Mot}) Sign function sign (ω_{Mot})=1, if ω_{Mot}≥0, −1 otherwise
   K_{D} Parameter for damping

The parameter μ₊₋ represents the increase in the torque loaded on the motor M_{Last}=F_{Sp}*i on the basis of the mechanical efficiency η according to:

$$μ = ( 1 / η ) - 1$$

The method for controlling the actuator firstly provides for detecting a braking force request. For this purpose, an appropriate, corresponding setpoint application force F_{Sp,soll} is determined, which defines the setpoint force to be applied by the electromechanical wheel brake in order to achieve the desired deceleration. For this purpose, the embodiments provide a correspondingly designed force controller, which can be implemented in the brake control unit. The braking force request or else the setpoint application force F_{Sp,soll} can be provided, for example, by a pedal unit or a superordinate vehicle computer. On the basis of the braking force request, a setpoint position can be determined for the actuator X_{Akt,Soll}. This setpoint position determines the position of the actuator at which the desired braking force or the setpoint application force F_{Sp,soll} is adjusted at the wheel brake.

Accordingly, the carrying out of an initialization function is provided. This initialization function is carried out when there is a corresponding activation condition for carrying out the initialization function.

For example, this initialization function is activated directly after the control unit is switched on or, if required, can also be activated as operation is in progress.

The activation condition therefore comprises switching on of the actuator or the brake control unit or the vehicle computer for the first time and/or the absence of a braking force request, for example over a predefined period of time. For example, the predefined period of time may be a few seconds or preferably at least a few minutes.

The initialization function is therefore for example carried out directly after the brake control unit is switched on or else while operation is in progress, during a phase in which no braking force request is made to the actuator. While operation is in progress and in the absence of a braking force request, a test condition can be defined. The initialization function can then be carried out when the test condition is present.

The test condition can be linked, for example, to an internal counter in order, for example, to initiate an initialization function after a predetermined number of braking operations. It can also be provided that the duration and/or the strength of the braking is also taken into account in the consideration of the braking operations.

This initialization function determines a first offset position X_{Offset,1}, in which the two friction partners are just touching each other. In this position, the actuator travel X_{Aktuator} is set to the value 0.

The initialization function provides that the actuator is moved in the application direction at a defined, but low motor rotational speed ω_{Mot,Ini} and/or at a limited motor torque M_{Mot,Ini}. The initialization function therefore provides the following steps in the sequence indicated:
activating the actuator at a predetermined rotational speed ω_{Mot,Ini} and/or a predetermined motor torque M_{Mot,Ini},
detecting the associated actuator position X_{Aktuator}=X₁, at which the motor rotational speed of the actuator assumes a value of approximately 0 rpm and/or at which the actuator position remains approximately constant,
determining the first offset position X_{Offset,1} from the associated actuator position X₁ and the offset position X_{Offset,1} defined for this initialization function.

The resulting actuator position X_{Aktuator} then assumes the value 0 when the two friction partners are just touching each other.

When the motor rotational speed of the actuator approaches or reaches the value 0 rpm, since the counter-force increases because of the contact and since the motor torque M_{Mot,Ini} is limited, and/or if the specific current actuator position does not change further or remains substantially constant, the point defined as the contact position is reached within the meaning of the embodiments. In this contact position, the corresponding friction partners can just touch each other, with only a very small force being applied.

For this purpose, FIG. 3 shows the relationship between the setpoint tensioning force F_{SP} and application travel X_{Akt} of the actuator with the first offset position X_{Offset,1}. If a standstill is detected at the actuator position X₁, the contact position X_{SP}=0 is determined by the actuator position being corrected at the standstill X_{Aktuator}=X₁ by said first offset position X_{Offset,1}. It is taken into account here that, during the detection movement, a (low) application force F₁ has already been built up, as can be seen in FIG. 3. This procedure corresponds to a reinitialization of the zero point of the actuator position X_{Aktuator}. The setpoint position of the actuator X_{Akt,Soll} therefore does not have to be corrected by the determined first offset position X_{Offset,1}. The present embodiments thus provide the possibility of being able to detect the contact position with very high precision and use same for controlling the actuator or for force control.

The actuator is then activated in order to apply the setpoint application force F_{Sp,soll} corresponding to the desired braking force request, with the actuator position X_{Akt,Soll}, provided that an initialization has taken place. In this way, a change in the release clearance can be compensated for. If no initialization takes place, the actuator can be activated as standard with the actuator position X_{Akt,Soll}, according to the characteristic curve.

For example, a low motor rotational speed of the actuator during the initialization function means a rotational speed ω_{Mot,Ini} for which the following applies:

$${ω}_{Mot , Ini} = {ω}_{Mot , max} * p , where 0.01 < p < 0.3 .$$

According to an embodiment, the motor rotational speed of the actuator during an initialization can be between 1% and 30%, for example between 2% and 9% and e.g. between 3% and 8% of the maximum possible motor rotational speed of the actuator ω_{Mot,max}, for example, 5% of the maximum rotational speed, with p indicating the associated parameter.

A limited motor torque M_{Mot,Ini} can be determined according to the following rule:

$${M}_{Mot , Ini} = {M}_{C 0 +} * k , where 1 < k < 30.$$

Here, M_{C0+} indicates the basic friction in the application direction, with the parameter k being able to indicate how far the limit may be above this basic friction. A value for k is between k=1 and k=30; for example a value for k can be, for example, between k=2 and k=5. During acceleration at the start of the initialization movement, the value for the parameter k can also be selected to be greater, so that k>10 applies.

During a brake actuation requested during operation, the corresponding actuator position X_{Akt,Soll}=X_{Akt,Soll,FCtrl} can be adjusted on the basis of the setpoint application force F_{Sp,soll}.

A development can make provision to check this initialized contact position and optionally to further adjust it as the operation progresses or to reduce the deviation. This can be done during operation, i.e., for example, during a journey in the motor vehicle. In this way not only can the first offset position X_{Offset,1} be continuously checked and further corrected, but also further changes that may result from the operation of the wheel brake can be taken into account. This may include, for example, greater wear of a friction partner, such as the brake linings, during a long downhill descent.

For this purpose, the course of the motor torque is continuously monitored during an application movement. The fact that the motor torque to be applied by the actuator is proportional to the applied tensioning force is taken as the basis here. If acceleration- and/or speed-dependent components are taken into account, the result is a so-called normalized motor torque adjusted for these components, wherein the term normalized motor torque M_{F,Norm} should be understood in the sense of a motor torque corrected by the described torque components:

$${M}_{F , Norm} = {M}_{Mot} - {J}_{Ges} * d ( {ω}_{Mot} ) / dt - {K}_{D} * {ω}_{Mot}$$

The normalized motor torque signal determined in this way can subsequently be monitored during each application operation from an unactuated state to exceeding of a predefined torque threshold

$${M}_{LS , Korr , Limit} = {k}_{LS , Korr , Limit} * {M}_{C 0 +} .$$

For the correction factor k_{LS,Korr,Limit}, the following applies: 1<k_{LS,Korr,Limit}<30.

As long as the actuator moves in the release clearance, the following applies:

$${M}_{F , Norm} = {M}_{C 0 +} .$$

As soon as the friction linings are positioned on one another and/or pressed together, the actuator begins to build up a tensioning force. The following applies here for the normalized motor torque:

$${M}_{F , Norm} = {M}_{C 0 +} + i * {F}_{Sp} * ( 1 + {μ}_{+} )$$

If the normalized motor torque M_{F.Norm} exceeds the predefined torque threshold M_{LS,Korr,Limit} for the application movement under consideration, the currently determined contact position X_{LS,Aktuell} can be determined from the associated actuator position X₂ and corrected by a second offset value X_{Offset,2}, so that the following applies:

$${X}_{LS , Aktuell} = {X}_{2} - {X}_{Offset , 2}$$

Said contact position can then be corrected, for example, by means of a further correction value ΔX_{LS,Korr}, with the currently determined contact position, according to an embodiment, being additionally able to be weighted with a tracking factor λ:

$$Δ {X}_{LS , Korr} = λ * Δ {X}_{LS , Korr} + ( 1 - λ ) * {X}_{LS , Aktuell}$$

When determining the tracking factor λ, it is useful to find a compromise between the stability and sufficiently good filtering, on the one hand, which indicates a λ close to one, and a high adjustment speed, which indicates a small λ, for example close to zero, and to select λ accordingly. For example, the tracking factor λ lies in the following range: 0.3<=λ<=0.6.

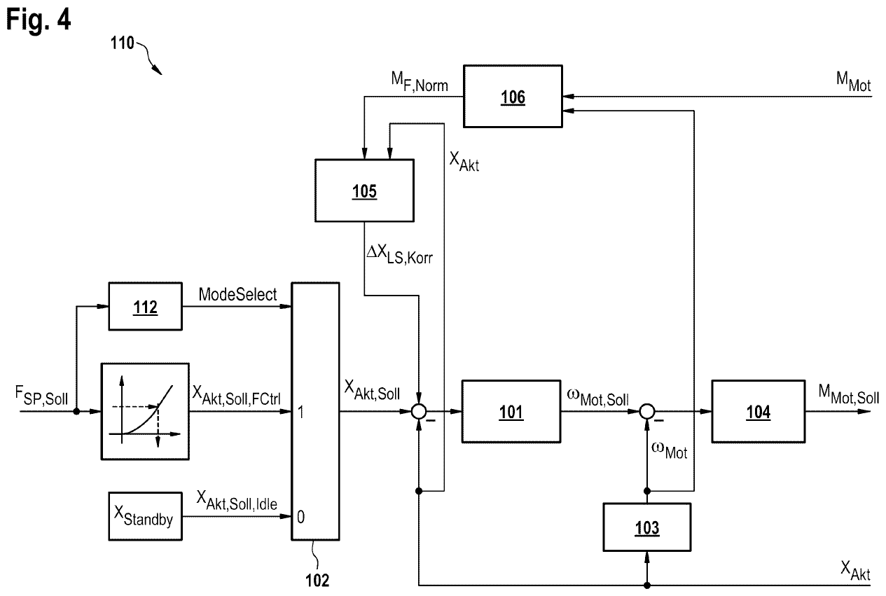

FIG. 4 shows for this purpose a simplified exemplary block diagram of a basic structure of a force controller 110. The above-described correction of the contact position or of the contact point is implemented in a function block 105 for contact detection and readjustment. Furthermore, a function block 106 for determining the normalized motor torque is provided. Furthermore, a function block 103 for determining the motor rotational speed and a function block 104, which represents the motor rotational speed controller, are provided.

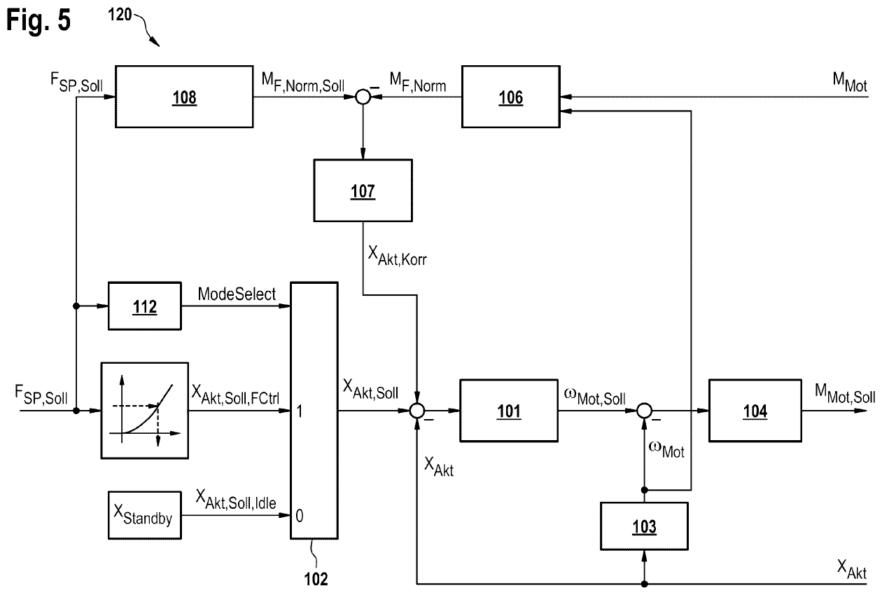

For the realization of the above-mentioned methods, the force controller according to a further embodiment is supplemented by a characteristic curve correction controller 107. The force controller and/or characteristic curve correction controller 107 is/are implemented in the brake control unit. FIG. 5 shows a simplified exemplary block diagram of a basic structure of such a force controller 120 with a characteristic curve correction controller 107.

The characteristic curve correction controller 107 is designed to generate a correction position X_{Akt,Korr} as the manipulated variable for correcting the actuator setpoint position X_{Akt,Soll,FCtrl} determined on the basis of the characteristic curve. The calculation of the normalized setpoint motor torque M_{F,Norm,Soll} in accordance with the requested setpoint application force F_{SP,Soll} is based on the fact that the motor torque to be applied by the actuator is proportional to the applied tensioning force.

If the friction parameters are still taken into account, such as the mechanical efficiency or the static friction of the electromechanical drive train, the following can be specified as the setpoint value for the normalized motor torque M_{F,Norm,Soll}:

$${M}_{F , Norm , Soll} = f ( {F}_{SP , Soll} , d {F}_{SP , Soll} / dt , {M}_{C} , i , η )$$

The model described with a mass and friction then leads to the realization of the function module 108 for determining the normalized setpoint motor torque. If a force build-up or a holding of the actuator is required, i.e. d F_{SP,Soll}/dt³ 0, then the following applies:

$${M}_{F , Norm , Soll} = i * {F}_{SP , Soll} * ( 1 + {μ}_{+} ) + {M}_{C 0 +}$$

In the event of a force reduction, i.e. d F_{SP,Soll}/dt<0, the following is then obtained:

$${M}_{F , Norm , Soll} = i * {F}_{SP , Soll} * ( 1 + {μ}_{-} ) - {M}_{C 0 -}$$

To determine the actual value for the normalized motor torque M_{F,Norm}, the motor torque M_{Mot} determined with the aid of the measured motor current is adjusted by the acceleration- and speed-dependent torque components.

The structure of the characteristic curve correction controller 107 has a proportional and integral behavior, wherein for example the integral behavior brings about the desired correcting actuating interventions, while the proportionally acting component ensures sufficient actuating dynamics.

According to a development, it is provided to deactivate the characteristic curve correction controller 107 when a stationary target force is reached, while maintaining the current manipulated variable, since, in said stationary state, the actuator is in a static friction state in which the value for the stationary friction M_{C0} is not unambiguous. As long as the actuator is in the release clearance (i.e., X_{SP}<0, or X_{SP}<ΔX_{LS,Korr}), the correction controller is inactive and is in its initialization state with the manipulated variable correction position X_{Akt,Korr}=0.

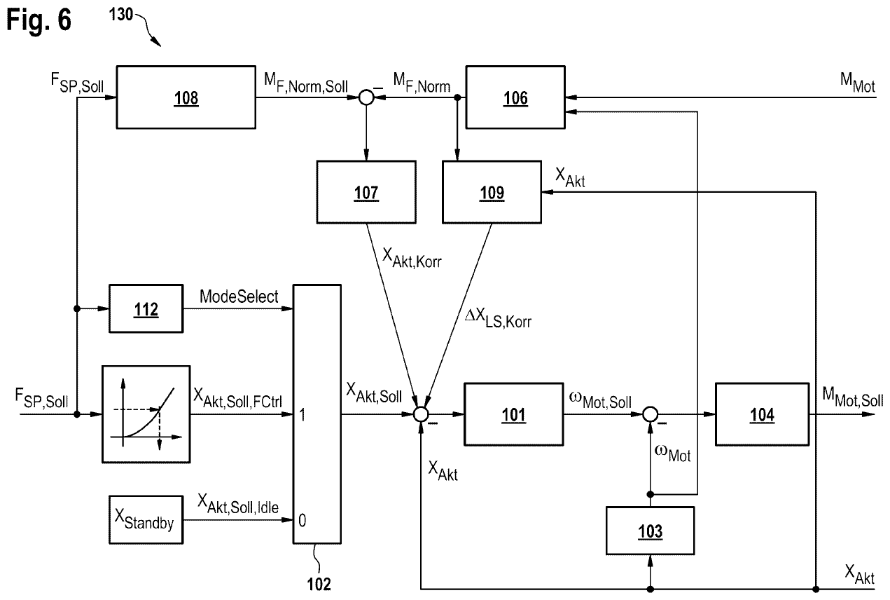

A simplified exemplary block diagram of an arrangement of a force controller 130 with lining contact detection and tracking and a characteristic curve correction controller is shown in FIG. 6, in which the two correction values can be additively superimposed. It has to be taken into account here that the correction value ΔX_{LS,Korr} has a corrective effect on the specific contact position, while the correction value X_{Akt,Korr} corrects the course of the characteristic curve F_{SP}=f(X_{SP}), as also shown in FIG. 2. Thus, the controller arrangement according to FIG. 6 allows two correction values acting independently of each other to be obtained.

According to another development, the characteristic curve can be changed, with the underlying characteristic curve function being able to be adjusted. For this purpose, provision is made to use the manipulated variable of the correction controller to adjust the force/displacement characteristic curve or the underlying characteristic curve function.

This can occur after the braking has ended and/or when the brake control unit is switched off, and therefore there can be no unfavorable influences on a pending or current braking event. The actuator is advantageously in the standby position. The correction values X_{Akt,Korr}, which were determined by the characteristic curve correction controller 107 during braking, are taken into consideration. According to a further embodiment, it is also possible to define a further correction parameter Kₖₒᵣᵣ, which can be determined on the basis of the correction values.

For simplification purposes, it is also possible to this end to adopt a model for changing the characteristic curve function F_{SP}=f(X_{SP}), according to which the new characteristic curve is obtained in a known contact position by stretching or compressing the original characteristic curve, so that the following applies:

$${F}_{SP , Neu} = f ( {K}_{Korr} * {X}_{SP} )$$

With this adoption, the following then applies:

$${X}_{Akt , Soll , {FCtrl}^{*}} + {X}_{Akt , Korr} = {K}_{korr} * {X}_{Akt , Soll , {FCtrl}^{*}}$$

The variable X_{Akt,Soll,FCtrl}* represents the actuator setpoint position X_{Akt,Soll,FCtrl} minus the contact point correction ΔX_{LS,Korr}:

$${X}_{Akt , Soll , {FCtrl}^{*}} = {X}_{Akt , Soll , FCtrl} - Δ {X}_{LS , Korr}$$

If the contact point correction is deactivated, the following applies:

$${X}_{Akt , Soll , FCtrl}^{*} = {X}_{Akt , Soll , FCtrl}$$

If, in addition, a defined minimum value for the setpoint position of the actuator X_{Akt,Soll,FCtrl,Min}>0 is considered, then the following furthermore applies:

$${K}_{korr} = ( {X}_{Akt , Soll , FCtrl}^{*} + {X}_{Akt , Korr} ) / {X}_{Akt , Soll , FCtrl}^{*}$$

X_{Akt,Soll,FCtrl,Min} can also be defined in such a way that the lower, “soft” range of the force/displacement characteristic curve is not taken into account for the characteristic curve correction.

In accordance with the above-mentioned equation, a current value for the correction parameter Kₖₒᵣᵣ is determined during the actuation of the wheel brake and with an activated correction controller (“ModeSelect”=1) in each controller sampling step. The value determined in this way can be filtered again to smooth out fluctuations and interference excitation. The value K_{korr,Filt} is then obtained. The new characteristic curve correction value K_{k,Korrektur} is then calculated after braking has ended:

$${K}_{k , Korrektur} = ( {K}_{korr , Filt} + α ) / ( α + 1 )$$

The parameter α (0<α) determines the extent to which the correction values determined during braking are taken into account, it holding true that for α=0 the specified value for K_{k,Filt} is adopted at 100%. The definition of a therefore takes place under the aspect of whether high adjustment dynamics or a sufficiently good filtering and stability of the model is required.

The model or the characteristic curve function F_{SP}=f(X_{Akt}) is adjusted in accordance with an embodiment before braking by:

$${F}_{SP , Neu} = f ( {K}_{K , Korrektur} * {X}_{SP} ) .$$

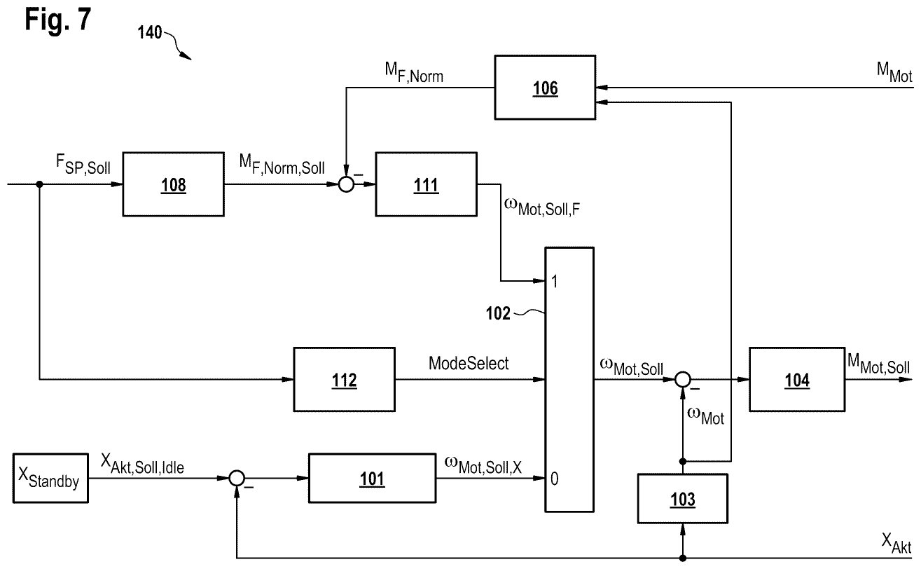

According to a further development, it may also be provided to use a controller structure, which does not require a characteristic curve function as described above and can therefore be further simplified. FIG. 7 shows for this purpose a simplified block diagram of an exemplary, simplified force controller 140.

As with the above-mentioned characteristic curve correction controller 107, in this method, the setpoint application force can be converted into a corresponding value for the normalized setpoint motor torque M_{F,Norm,Soll} and the normalized motor torque M_{F,Norm} can be considered to be the control variable.

The basic structure of this controller structure can comprise two controllers which are arranged in parallel and which both determine a setpoint value for the motor rotational speed ω_{Mot,soll} as the manipulated variable. Depending on the setpoint application force F_{Sp,soll}, a controller component may be provided, which decides which of these two setpoint values is supplied to a subordinate motor rotational speed controller.

If the setpoint application force is F_{SP,Soll}=0 or less than a deactivation threshold F_{SP,Soll,Eps_1}, the brake can be released and the release clearance approached by stipulation of the target position X_{Standby} with the aid of the actuator position controller 101, or the wheel brake remains in this position. In this case, the “ModeSelect” signal has the value 0 and the following applies:

$${ω}_{Mot , soll} = {ω}_{Mot , soll , X} .$$

If the setpoint application force is F_{SP,Soll}>0 or greater than an activation threshold F_{SP,Soll,Eps_2}, the “ModeSelect” signal can be set to the value 1, and the following applies:

$${ω}_{Mot , soll} = {ω}_{Mot , soll , F} .$$

Another controller, shown in the example of FIG. 7 as a standard torque controller 111, may be designed to determine, on the basis of the difference between the normalized setpoint motor torque M_{F,Norm,Soll} and the normalized motor torque M_{F,Norm}, the setpoint rotational speed ω_{Mot,Soll,X} as the manipulated variable in order to adjust the requested setpoint application force F_{Sp,Soll}. It can therefore act as a force controller. This controller may have a proportionally acting behavior; additional components (e.g. I component or D component) are optional. Furthermore, according to another embodiment, it can also be provided that the proportional component has a nonlinear characteristic, e.g. so that the controller can work with higher gain factors in the release clearance and in the lower force range, where the stiffness of the wheel brake is still low, than in a high force range, in which the stiffness of the wheel brake is substantially greater.

According to a further development, it can be provided that, in a force-holding phase, the motor torque M_{Mot} is reduced by the stipulation of a modified setpoint torque, since predetermined tensioning forces are adjusted by stipulation of normalized motor torques.

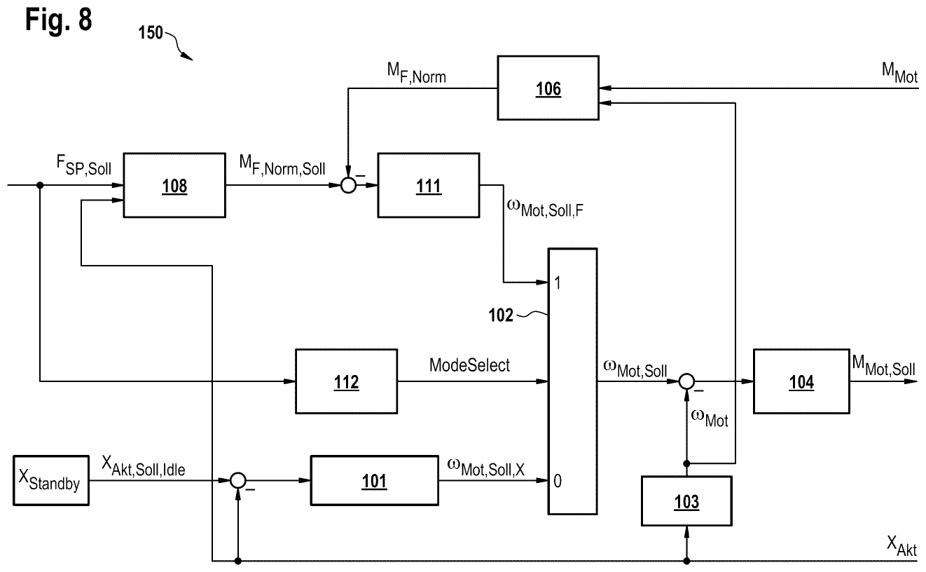

FIG. 8 shows for this purpose a simplified exemplary block diagram of the controller structure of the force controller 140 from FIG. 7 with an extension. In the force controller 150 shown in FIG. 8, a force-holding phase can be detected by the fact that the setpoint force gradient is approximately equal to the value 0 and the ensuing actuator position is also detected as being approximately constant. In this case, the value for M_{F,Norm,Soll} is then gradually reduced, as long as it holds true that

$${M}_{F , Norm , Soll} > {k}_{TrqRed} * ( i * {F}_{Sp , Soll} * ( 1 - {μ}_{-} ) + {M}_{C 0 , -} )$$

and the actuator position does not change in the direction of release of the wheel brake under consideration during this operation. The safety factor k_{TrqRed} represents a safety distance from the setpoint motor torque in the event of a force reduction. The safety factor k_{TrqRed} is in any case greater than one and smaller than the following quotient

$$i * {F}_{SP , Soll} * ( 1 + {μ}_{+} ) + {M}_{C 0 , +} ) / ( i * {F}_{SP , Soll} * ( 1 - {μ}_{-} ) - {M}_{C 0 , -} .$$

The embodiments furthermore comprise, in a further aspect, a brake control unit, designed for controlling an actuator, for example a brake actuator of an electromechanical wheel brake, by means of a method as explained above. For this purpose, the brake control unit has at least one force controller 100, 110, 120, 130, 140 or 150, which is designed to determine a correction position X_{Akt,Korr} as the manipulated variable for correcting the actuator setpoint position X_{Akt,Soll,FCtrl}.

The embodiments furthermore comprise, in yet another aspect, a motor vehicle having a motor vehicle brake, for example comprising at least one electromechanical wheel brake, having at least one brake control unit as referred to above.

The present embodiments thus permits the application of requested, defined forces in an electromechanical wheel brake of a motor vehicle brake without the use of a corresponding force sensor and using the force information already contained in the motor torque and motor angle or motor position signals.

1. A method for controlling an actuator of an electromechanical wheel brake, comprising:
determining a setpoint application force;
determining a corresponding setpoint position of the actuator for applying the setpoint application force;
carrying out an initialization function for determining a first offset position as the zero point of the coordinate system for determining the setpoint position of the actuator from the setpoint application force, when there is an activation condition for carrying out the initialization function;
determining a second offset position when a motor torque threshold value is exceeded;
correcting the setpoint position of the actuator by means of a correction value ΔX_{LS,Korr} determined therefrom, wherein the following applies:
$${X}_{Akt , Soll , Korr} = {x}_{Akt , Soll} + Δ {X}_{LS , Korr ;}$$
and
activating the actuator to reach the setpoint position with the corrected setpoint position of the actuator.

2. The method as claimed in claim 1, wherein the activation condition comprises at least one of the following conditions:
switching on of the actuator or an associated brake control unit for the first time; and
the absence of a braking force request and/or the presence of a test condition.

3. The method as claimed in claim 1, wherein the carrying out of the initialization function comprises at least:
activating the actuator at a predetermined rotational speed and/or a predetermined motor torque;
detecting the associated actuator position X_{Aktuator}=X₁, at which the motor rotational speed of the actuator assumes a value of approximately 0 rpm and/or at which the actuator position remains approximately constant; and
determining the first offset position from the associated actuator position and the offset position X_{Offset,1} defined for this initialization function.

4. The method as claimed in claim 1, wherein the predetermined rotational speed satisfies the following rule:
$${ω}_{Mot , Ini} = {ω}_{Mot , m ax} * p , where 0.01 < p < 0.30 .$$

5. The method as claimed in claim 3, wherein the predetermined motor torque satisfies the following rule:
$${M}_{Mot , lni} = {M}_{C 0 +} * k , where 1 < k < 30 .$$

6. The method as claimed in claim 1, wherein, when the actuator is activated to reach the desired actuator position, the normalized motor torque is monitored and compared with a predetermined motor torque threshold value, the motor torque threshold value being established according to the following rule:
$${M}_{LS , Korr , Limit} = {M}_{C 0 +} * {k}_{LS , Korr , Limit} , where 1 < {k}_{LS , Korr , Limit} < 30 .$$

7. The method as claimed in claim 1, wherein the corrected actuator position for the contact position is determined from the second offset position and the actuator position determined when the motor torque threshold value is exceeded, wherein the following applies:
$${X}_{LS , Aktuell} = {X}_{2} - {X}_{Offset , 2} .$$

8. The method as claimed in claim 1, wherein the corrected actuator position for the contact position is corrected by means of a correction value ΔX_{LS,Korr}, wherein the following applies:
$$Δ {X}_{LS , Korr} = λ * Δ {X}_{LS , Korr +} * {x}_{LS , Aktuell} , where 0 < λ < 1 .$$

9. The method as claimed in claim 1, wherein a characteristic curve of a characteristic curve function is used to determine a corresponding setpoint position of the actuator for applying the setpoint application force.

10. The method as claimed in claim 1, wherein the characteristic curve function is adjusted after the end of braking and/or when the brake control unit is switched off.

11. The method as claimed in claim 1, wherein the manipulated variable of the correction controller is used for adjusting the characteristic curve.

12. The method as claimed in claim 1, wherein, in a force-holding phase, the motor torque M_{Mot} is reduced by the stipulation of a modified setpoint torque.

13. A brake control unit of an electromechanical wheel brake comprising: determining a setpoint application force;
an actuator; and
wherein the control unit comprises instructions for:
determining a corresponding setpoint position of the actuator for applying the setpoint application force;
carrying out an initialization function for determining a first offset position as the zero point of the coordinate system for determining the setpoint position of the actuator from the setpoint application force, when there is an activation condition for carrying out the initialization function;
determining a second offset position when a motor torque threshold value is exceeded;
correcting the setpoint position of the actuator by means of a correction value ΔX_{LS,Korr} determined therefrom, wherein the following applies:
$$XAkt , Soll , Knorr = XAkt , Soll + Δ XLS , Korr ;$$
and
activating the actuator to reach the setpoint position with the corrected setpoint position of the actuator.

14. The brake control unit as claimed in claim 13, wherein the brake control unit comprises a characteristic curve correction controller, which determines a correction position X_{Akt,Korr} of the actuator as the manipulated variable for correcting the actuator setpoint position X_{Akt,Soll,FCtrl}.

15. The brake control unit as claimed in claim 14, wherein the brake control unit comprises at least two controllers which are arranged in parallel and determine a setpoint value for the motor rotational speed ω_{Mot,soll} as the manipulated variable.

16. The brake control unit as claimed in claim 13, wherein the brake control unit is for a motor vehicle.
